(19) United States
(12) Patent Application Publication
(10) Pub. No.: US 2026/0175761 A1
(43) Pub. Date: Jun. 25, 2026

(54) CUP HOLDER

(71) Applicant: TOYODA GOSEI CO., LTD., Kiyosu-shi (JP)

(72) Inventor: Naoyuki FUKUI, Kiyosu-shi (JP)

(21) Appl. No.: 19/405,520

(22) Filed: Dec. 2, 2025

(30) Foreign Application Priority Data
Dec. 24, 2024 (JP) 2024-226986

(51) Int. Cl. B60N 3/10

(52) U.S. Cl. CPC B60N 3/105

(57) ABSTRACT

A cup holder includes a tray portion configured to be vertically movable, and a lock mechanism. The lock mechanism includes a linkage member, an urging member, an intermediate member, and an engagement portion. The linkage member moves in a first direction when the tray portion is lowered, and moves in a second direction when the tray portion is raised. The urging member urges the linkage member in the second direction. The intermediate member moves between a first position and a second position. When the intermediate member is located at the second position, the engagement portion restricts movement of the linkage member in the second direction to lock the tray portion against upward movement. When the intermediate member is located at the first position, the engagement portion allows movement of the linkage member in the second direction to unlock the tray portion, thereby allowing the tray portion to move upward.

### CROSS-REFERENCE TO RELATED APPLICATIONS

This application is based upon and claims the benefit of priority from Japanese Patent Application No. 2024-226986, filed on December 24, 2024, the entire contents of which are incorporated herein by reference.

### BACKGROUND

### 1. Field

The present disclosure relates to a cup holder configured to hold a beverage container.

### 2. Description of Related Art

JP2020-1634A discloses a multi-stage elevating holder as one form of a cup holder that is installed in a passenger compartment of a vehicle to hold a beverage container. The multi-stage elevating holder includes a height positioning mechanism. The height positioning mechanism includes groove-shaped holder-side engaging portions and inner protrusion. The holder-side engaging portions are provided at intervals in the vertical direction on the peripheral wall of the holder main body. The inner protrusion protrudes from the outer peripheral portion of the tray portion and engages with the holder-side engaging portions.

According to the multi-stage elevating holder described above, the height position of the tray portion relative to the holder main body can be switched among three levels (a top position, an intermediate position, and a bottom position) by changing the position of the inner protrusion at which the inner protrusion engages with the corresponding holder-side engaging portion.

Various beverage containers having different heights are placed on the tray portion. A cup holder is required to stably accommodate tall beverage containers while also allowing shorter beverage containers to be easily removed. Each beverage container has an optimal height position of the tray portion. Accordingly, it is desirable that the height position of the tray portion be adjustable to any desired height position depending on the height of the beverage container.

However, in the conventional cup holder (the multi-stage elevating holder) described above, the positions of the holder-side engaging portions are fixed. Therefore, the adjustable height positions of the tray portion are limited to the three levels mentioned above. The height position of the tray portion cannot be adjusted to a desired height position corresponding to the height of the beverage container.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a cup holder is configured to hold a beverage container and includes a tray portion configured to be vertically movable and configured such that the beverage container is placed thereon, and a lock mechanism configured to releasably lock the tray portion against upward movement. The lock mechanism includes a linkage member, an urging member, an intermediate member, and an engagement portion. The linkage member is operatively connected to the tray portion, includes a first tooth portion, moves in a first direction when the tray portion is lowered, and moves in a second direction opposite to the first direction when the tray portion is raised. The urging member urges the linkage member in the second direction. The intermediate member includes a second tooth portion in mesh with the first tooth portion, and moves between a first position and a second position located forward of the first position in the second direction. The engagement portion is configured such that, when the intermediate member is located at the second position, the second tooth portion is engaged with the engagement portion so that the engagement portion restricts movement of the linkage member in the second direction to lock the tray portion against upward movement. The engagement portion is also configured such that, when the intermediate member is located at the first position, the second tooth portion is disengaged from the engagement portion so that the engagement portion allows movement of the linkage member in the second direction to unlock the tray portion, thereby allowing the tray portion to move upward.

Other features and aspects will be apparent from the following detailed description, the drawings, and the claims.

### BRIEF DESCRIPTION OF THE DRAWINGS

FIG. 1 is a perspective view of a cup holder according to an embodiment.

FIG. 2 is a side view of the cup holder of the embodiment as viewed from a direction different from that of FIG. 1.

FIG. 3 is a perspective view showing selected components of the cup holder of the embodiment.

FIG. 4 is a cross-sectional view showing the selected components of the cup holder of the above embodiment.

FIG. 5 is an enlarged partial cross-sectional view illustrating section X in FIG. 4.

FIG. 6 is a partial side view showing selected components of the cup holder shown in FIG. 2.

FIG. 7 is a cross-sectional view of the cup holder in which the tray portion is at the uppermost position in the embodiment.

FIG. 8 is a partial cross-sectional view showing selected components of the cup holder in which the tray portion is at the uppermost position in the embodiment.

FIG. 9 is a partial cross-sectional view showing selected components of the cup holder in an intermediate state in which the tray portion is being lowered from the state shown in FIG. 8.

FIG. 10 is a cross-sectional view of the cup holder of the embodiment in which the tray portion is at a lowermost position.

FIG. 11 is a partial cross-sectional view showing selected components of the cup holder when, with the tray portion at the lowermost position, a rod is pushed down to a pushed-down position in the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a cup holder for a vehicle will be described with reference to the drawings.

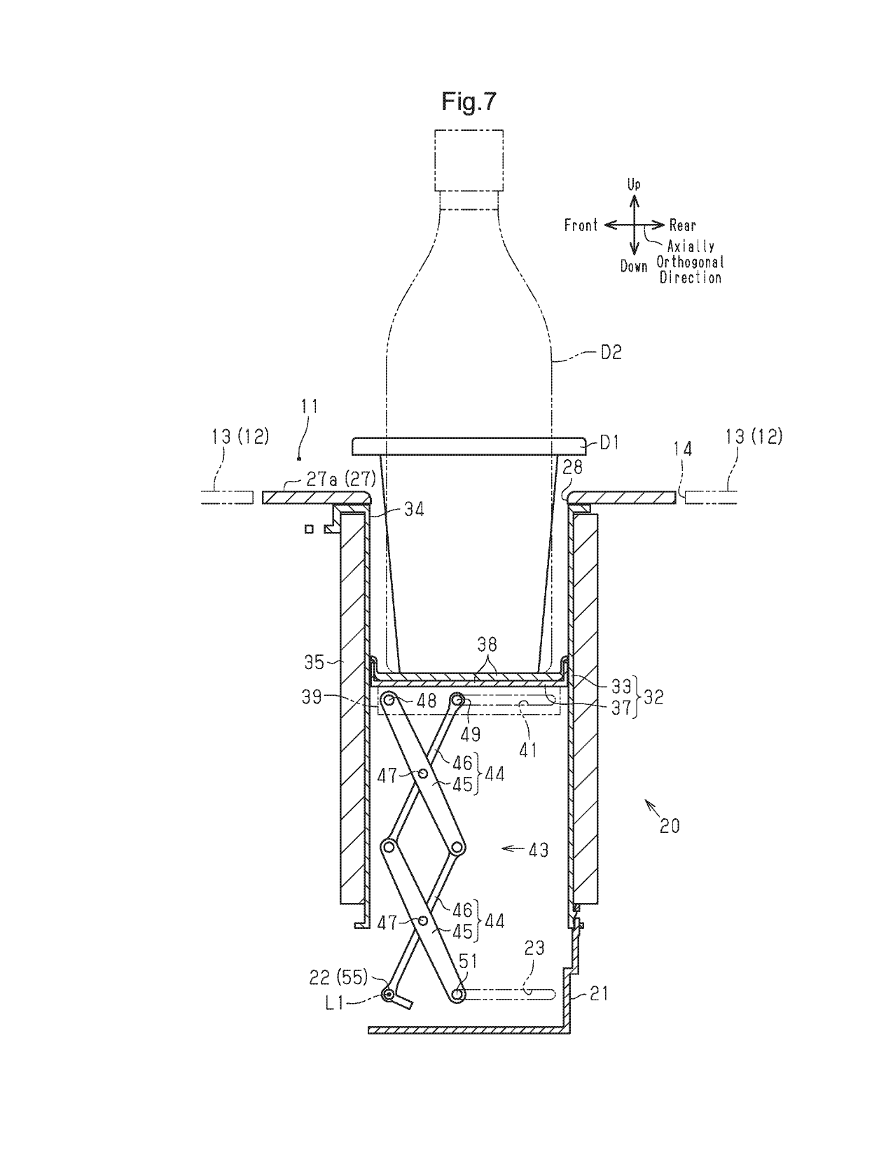

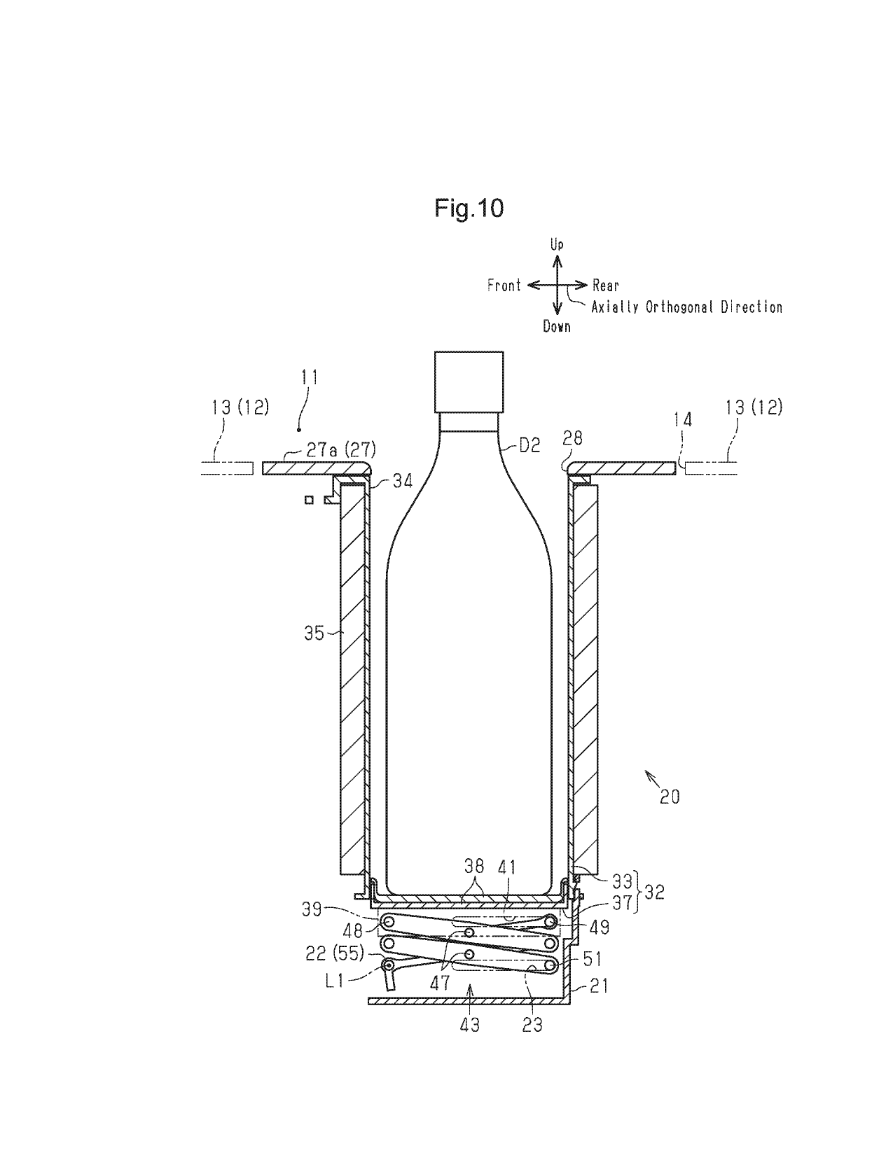

As shown in FIGS. 7 and 10, the cup holder 20 is used to hold various beverage containers D1 and D2 having different heights in the passenger compartment 11, and is also called a drink holder. In FIGS. 7 and 10, a beverage container D1 having a low height and a beverage container D1 having a height higher than that of the beverage container D2 are shown as examples of various beverage containers having different heights. Examples of the beverage container D1 include a cup with a cover and a beverage can having a small height. Examples of the beverage containers D2 include plastic bottles, tall beverage cans, and the like.

The cup holder 20 is installed in the passenger compartment 11. This installation may be performed by integrating the cup holder 20 into an interior component 12 (e.g., a console box) of the passenger compartment 11. Additionally, the installation may be performed by independently attaching the cup holder 20 in the passenger compartment 11. When the cup holder 20 is incorporated into the interior component 12, an opening 14 is formed in an upper wall 13 of the interior component 12.

### Basic Structure of Cup Holder 20

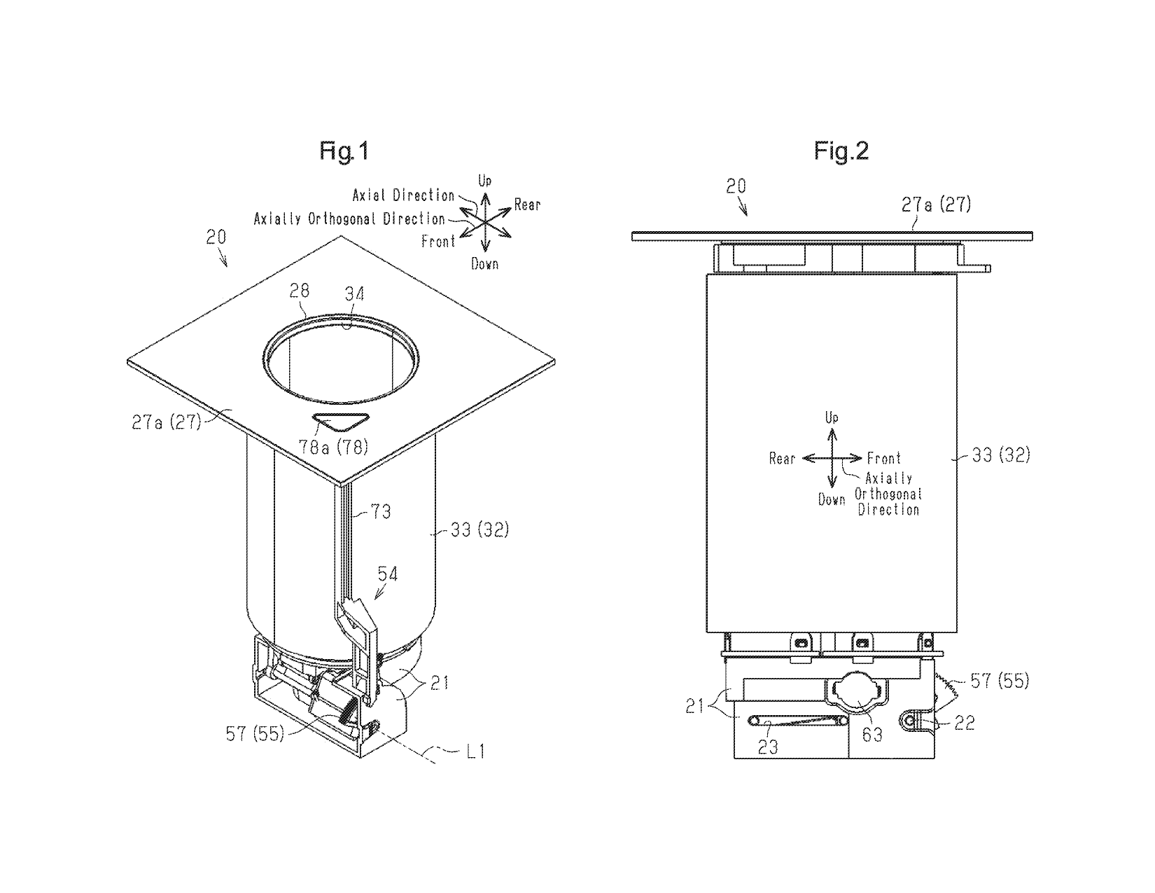

As shown in FIGS. 1 to 3, the cup holder 20 includes a lower case 21 at a lower portion thereof. A rotation shaft 22 is rotatably supported by the lower case 21. A direction in which an axial line L1 of the rotation shaft 22 extends is defined as an axial direction. Further, a direction orthogonal to both the axial direction and the vertical direction is referred to as an axially orthogonal direction. When it is necessary to distinguish one side from the other side in the axially orthogonal direction, the former is referred to as “front” and the latter is referred to as “rear” for purposes of illustration.

As shown in FIGS. 7 and 10, the lower case 21 is formed with a pair of elongated holes 23 spaced apart from each other in the axial direction (direction perpendicular to the plane of the drawing) and extending in the axially orthogonal direction.

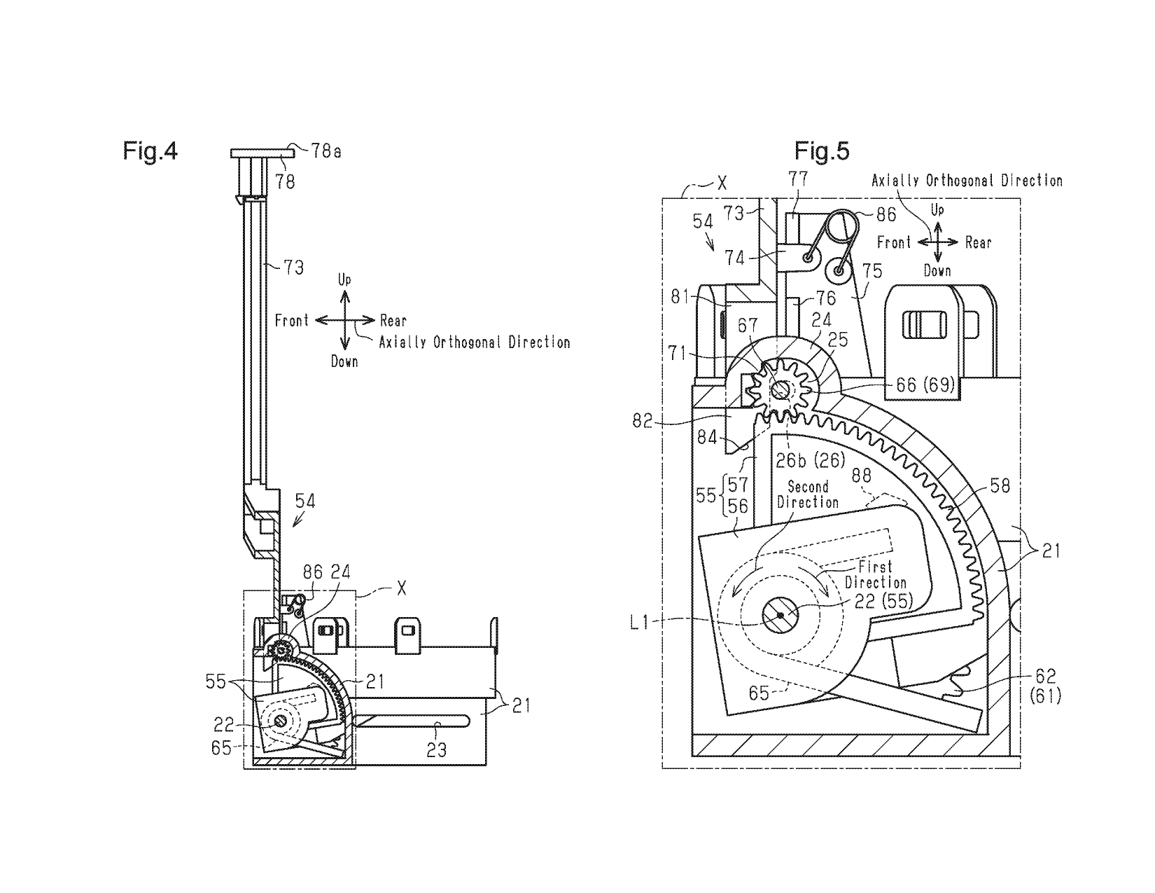

As shown in FIGS. 4 and 5, a semi-cylindrical planetary gear accommodating portion 24 extending in the axial direction with its lower end opened is formed in an upper portion of the lower case 21. Both ends of the planetary gear accommodating portion 24 in the axial direction are constituted by a pair of walls 25. An elongated hole 26 extending in the axially orthogonal direction is formed in each of the pair of walls 25.

As shown in FIGS. 1, 2, and 7, the cup holder 20 includes a top plate 27 at an upper end thereof. The top plate 27 is disposed in the opening 14. The top plate 27 has an upper surface 27a, which defines the upper surface of the cup holder 20. The top plate 27 includes a circular opening 28. The inside diameter of the opening 28 is set to such a size that at least the lower parts of the beverage containers D1 and D2 can be inserted in the vertical direction.

The cup holder 20 includes an accommodation portion 32 having an opening at an upper end thereof. The accommodation portion 32 includes a cylindrical side wall 33 and a tray portion 37. At least lower parts of the beverage containers D1 and D2 are housed in the accommodation portion 32.

The side wall 33 extends in the vertical direction, and has the form of a cylinder with both the upper and lower ends open. The upper end of the side wall 33 has an opening 34, defining the opening of the accommodation portion 32. The opening 28 of the top plate 27 and the opening 34 of the side wall 33 function as entrances and exits of the beverage containers D1 and D2.

A lower portion of the side wall 33 is attached to the lower case 21. An upper end of the side wall 33 is attached to the top plate 27. The inner diameter of the side wall 33 is set to the same as or almost the same as the inner diameter of the opening 28 of the top plate 27 at any position of the side wall 33 in the vertical direction. By such setting, the side wall 33 can surround the beverage containers D1 and D2 placed on the tray portion 37.

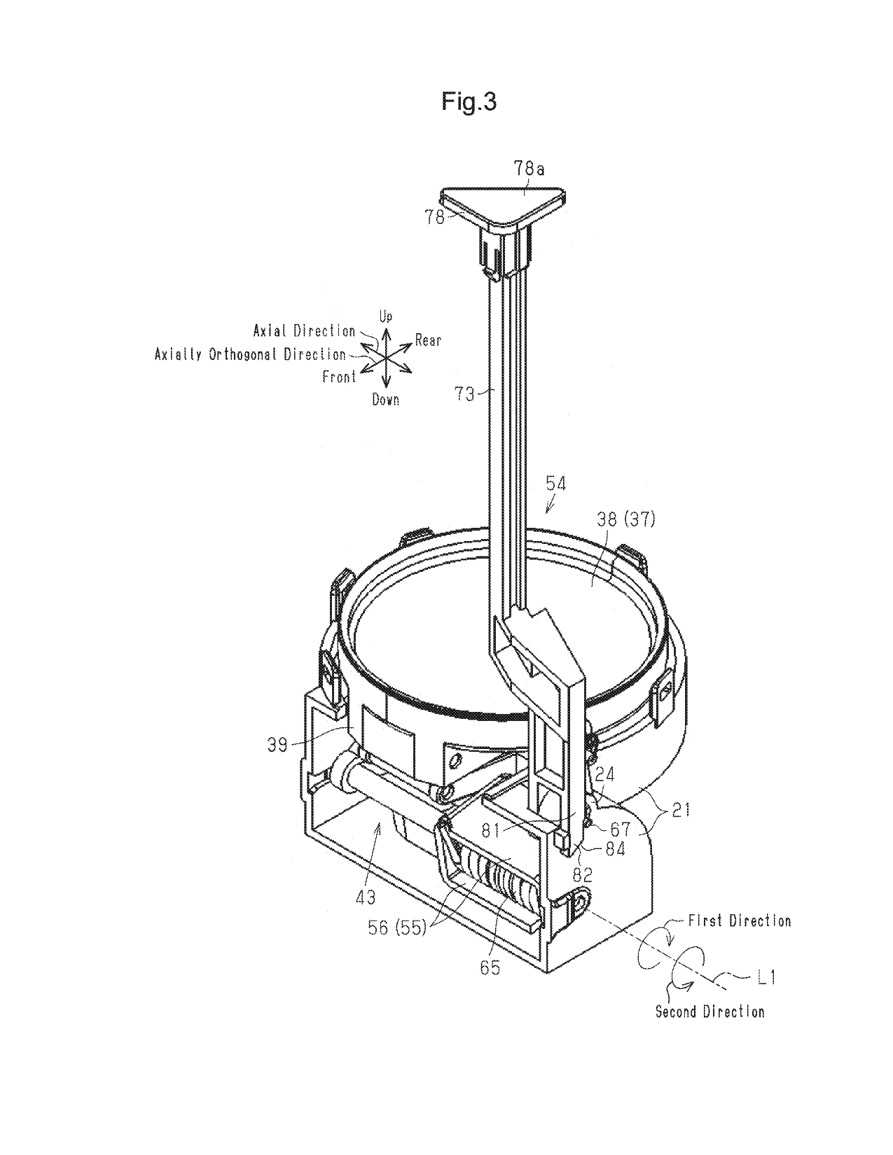

As shown in FIGS. 3 and 7, the tray portion 37 includes a disk-shaped placement portion 38 on which the beverage containers D1 and D2 are placed, and a mechanism coupling portion 39 disposed below the placement portion 38. The outer diameter of the placement portion 38 is set to be slightly smaller than the inner diameter of the side wall 33. The mechanism coupling portion 39 is formed with a pair of elongated holes 41 that extend in the axially orthogonal direction and are spaced apart from each other in the axial direction.

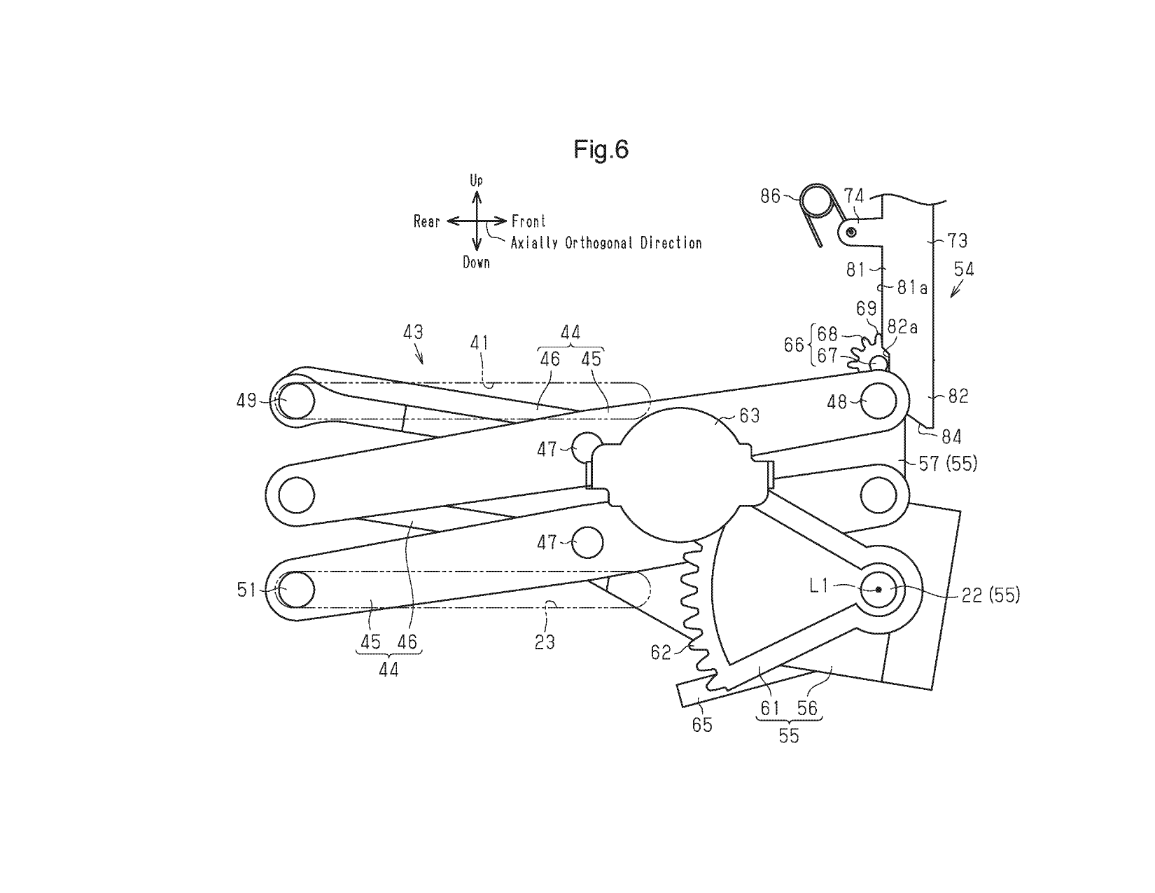

As shown in FIGS. 6 and 7, the tray portion 37 is arranged in the side wall 33 so as to be vertically movable. The tray portion 37 is moved vertically by expanding and contracting a pantograph type link mechanism 43 in the vertical direction. The link mechanism 43 is configured by rotatably connecting ends of multiple (two in the present embodiment) cross links 44. Each of the cross links 44 includes a plate-like arm member 46, and a pair of arm members 45 which are disposed on both sides of the arm member 46 in the axial direction and each of which has an elongated shape. The pair of arm members 45 of each cross link 44 are opposed to each other in the axial direction with the arm member 46 interposed therebetween. The arm member 46 and the pair of arm members 45 of each cross link 44 cross each other in an X shape at the center in the length direction. The arm member 45 and the pair of arm members 46 of each cross link 44 are rotatably connected to each other by a connecting shaft 47 at the crossing portion.

An upper end of each arm member 45 of the uppermost (upper) cross link 44 is coupled to the mechanism coupling portion 39 by a shaft 48. Each arm member 45 is rotatable about the shaft 48 with respect to the mechanism coupling portion 39. A shaft 49 extending in the axial direction is provided at an upper end of the arm member 46 of the uppermost cross link 44. Both ends of the shaft 49 are inserted into the pair of elongated holes 41, respectively. The shaft 49 can move in the axially orthogonal direction along the pair of elongated holes 41 while rotating.

A lower end of the arm member 46 of the lowermost (lower) cross link 44 is connected to the rotation shaft 22. The arm member 46 is rotatable about the rotation shaft 22 with respect to the lower case 21. A shaft 51 extending in the axial direction is provided at a lower end of each arm member 45 of the lowermost cross link 44. The shaft 51 of each arm member 45 is inserted into the corresponding elongated hole 23. The shaft 51 of each arm member 45 can move in the axially orthogonal direction along the elongated hole 23 while rotating.

By rotating the rotation shaft 22 to change the angle formed by the arm members 45 and 46 in each cross link 44, the link mechanism 43 expands and contracts in the vertical direction. By this expansion and contraction, the tray portion 37 is moved vertically between the lowermost position shown in FIG. 10 and the uppermost position shown in FIG. 7 while being maintained horizontally.

As described above, when the link mechanism 43 expands and contracts in order to move the tray portion 37 vertically, the shafts 48 rotate in addition to the rotation shaft 22. Further, each shaft 51 moves in the corresponding elongated hole 23 in the axially orthogonal direction while rotating. The shaft 49 moves in the axially orthogonal direction in both elongated holes 41 while rotating.

As shown in FIG. 10, the lowermost position is set to a position where, when a tall beverage container D2 is placed on the tray portion 37, the upper end of the beverage container D2 is exposed by a certain distance from the upper surface 27a of the top plate 27. As shown in FIG. 7, the uppermost position is higher than the lowermost position, and is set at a position where the upper end of the beverage container D1 is exposed by a certain distance from the upper surface 27a of the top plate 27 when the beverage container D1 having a small height is placed on the tray portion 37.

As shown in FIGS. 7 and 10, a cylindrical heat insulating portion 35 is disposed on the outer peripheral portion of the side wall 33 in contact with the side wall 33. The heat insulating portion 35 is formed of a foamable resin material or the like. The side wall 33 is surrounded by the heat insulating portion 35. In the present embodiment, the heat insulating portion 35 is disposed on substantially the entire side wall 33 in the vertical direction. The heat insulating portion 35 suppresses heat transfer in the thickness-wise direction (radial direction) of the side wall 33, thereby suppressing changes in the temperatures of the beverage containers D1 and D2 themselves and the beverage therein for a long period of time.

Although not illustrated, the heat insulating portion 35 may be configured by a fiber heat insulating portion which is formed of a fiber heat insulating material having a gap between adjacent fibers and is laminated on the outer side of the side wall 33 in the thickness direction (radial direction). In addition, although not shown, the side wall 33 may have a layer structure which is formed of multiple layers laminated in the thickness direction (radial direction) of the side wall 33 and suppresses heat transfer in the same direction. That is, the side wall 33 itself may have a function as a heat insulating portion.

As shown in FIGS. 3 to 5, the cup holder 20 further includes a lock mechanism 54 for releasably locking the tray portion 37 against upward movement. The lock mechanism 54 includes a linkage member 55, an urging member 65, an intermediate member, and an engagement portion 71. Next, each part of the lock mechanism 54 will be described.

### Linkage Member 55

As shown in FIGS. 5 and 6, the linkage member 55 has the rotation shaft 22 as a part of its component. In addition, the linkage member 55 includes an accommodating case 56, a lifting gear 57, and a damper gear 61. The accommodating case 56 is disposed in the lower case 21 in a state of surrounding a part of the rotation shaft 22 in the axial direction. The accommodating case 56 is attached to the rotation shaft 22 so as to be integrally rotatable. The lifting gear 57 is formed at one end of the accommodating case 56 in the axial direction. The lifting gear 57 is coupled to the accommodating case 56 so as to be integrally rotatable. Therefore, the lifting gear 57 is operatively connected to the tray portion 37 (refer to FIG. 7 and the like) via the accommodating case 56, the rotation shaft 22, and the link mechanism 43. The lifting gear 57 has a first tooth portion 58 on an outer peripheral portion thereof.

The damper gear 61 has a fan-like shape and is formed at the other end of the accommodating case 56 in the axial direction. In other words, the damper gear 61 is located on the opposite side of the accommodating case 56 from the lifting gear 57. The damper gear 61 is coupled to the accommodating case 56 so as to be integrally rotatable. The damper gear 61 has a tooth portion 62 on an outer peripheral portion thereof.

A damper 63 such as an oil damper having a gear (not shown) is disposed around the tooth portion 62 of the damper gear 61. The tooth portion 62 of the damper gear 61 is meshed with a gear of the damper 63. The damper 63 applies resistance in the rotation direction to the rotation shaft 22 via the damper gear 61 by the viscosity of the oil. The damper 63 reduces the rotation speed of the rotation shaft 22 by the resistance, thereby moving the tray portion 37 vertically at an appropriate speed.

The linkage member 55 configured as described above pivots in the first direction about the rotation shaft 22 when the tray portion 37 is lowered. When the tray portion 37 is raised, the linkage member 55 rotates about the rotation shaft 22 in a direction opposite to the first direction, in the present embodiment, in a second direction which is an opposite rotation direction.

### Urging member 65

As shown in FIGS. 3 and 5, the urging member 65 urges the linkage member 55 in the second direction. In the present embodiment, a torsion coil spring is used as the urging member 65. The torsion coil spring is disposed around the rotation shaft 22 so as to be wound around the rotation shaft 22. One end of the urging member 65 is locked to the lower case 21 (see FIG. 5), and the other end is locked to the accommodating case 56.

### Intermediate Member

As shown in FIGS. 5 and 6, the intermediate member is constituted by a planetary gear 66 disposed around the lifting gear 57 by being disposed in the planetary gear accommodating portion 24. The planetary gear 66 includes a central shaft 67 that extends in the axial direction, and a planetary gear body 68 that has a second tooth portion 69 on an outer peripheral portion thereof and rotates about the central shaft 67. The second tooth portion 69 is meshed with the first tooth portion 58 of the lifting gear 57.

The planetary gear 66 can move while rotating between a first position shown in FIG. 9 and a second position set in front of the first position in the second direction as shown in FIG. 5. More specifically, both ends of the central shaft 67 are inserted into the pair of elongated holes 26 so as to be movable in the axially orthogonal direction.

### Engagement Portion 71

The engagement portion 71 protrudes from a part of the inner wall surface of the planetary gear accommodating portion 24. The engagement portion 71 is formed in front of the elongated hole 26 in the second direction and in front of the elongated hole 26 in the axially orthogonal direction. In other words, the engagement portion 71 is located forward of the front end 26b of the elongated hole 26 in the second direction in the axially orthogonal direction.

As shown in FIG. 5, when the second tooth portion 69 of the planetary gear 66 is engaged with the engagement portion 71, the engagement portion 71 restricts the movement of the linkage member 55 in the second direction and locks the tray portion 37 against upward movement. The position of the planetary gear 66 at this time is set as the second position. At this time, the central shaft 67 may be located at the end 26b of the elongated hole 26, or may be located rearward of the end 26b in the second direction.

Further, as shown in FIG. 9, when the central shaft 67 moves to the end 26a on the front side in the first direction of both ends of the elongated hole 26 in the axially orthogonal direction, the second tooth portion 69 is disengaged from the engagement portion 71. The position of the planetary gear 66 at this time is set as the first position.

### Rod 73

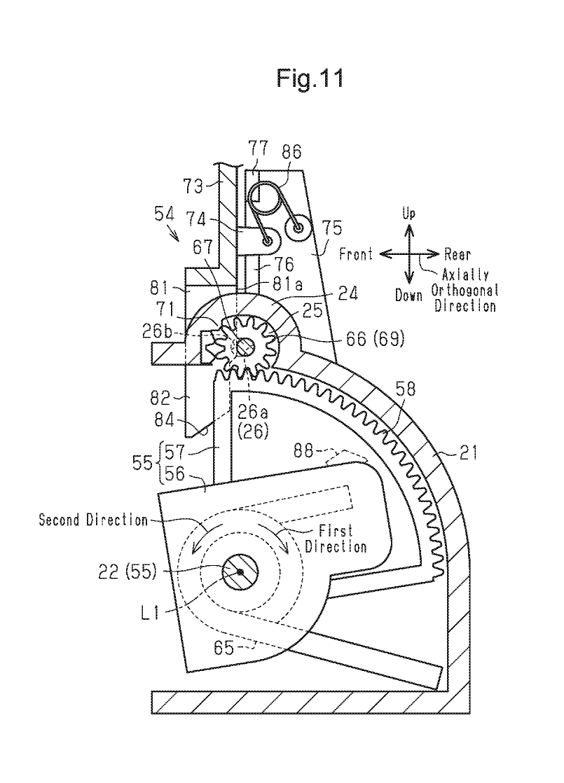

As shown in FIGS. 3 to 5, the lock mechanism 54 includes a mechanism for cancelling the lock. This mechanism includes the rod 73, a turnover spring 86, and a push-up portion 88 (see FIG. 5). The rod 73 is configured to be vertically movable between a reference position shown in FIG. 5 and a pushed-down position lower than the reference position as shown in FIG. 11. The rod 73 is vertically movably supported by support portions (not shown) provided at multiple positions of the cup holder 20 in the vertical direction, for example, an upper portion of the side wall 33, the lower case 21, and the like.

The rod 73 includes a protrusion 74 that protrudes rearward in the axially orthogonal direction. Further, a protruding wall 75 protruding upward is formed on the upper portion of the lower case 21. The protruding wall 75 includes a lower restricting wall 76 and an upper restricting wall 77 each extending in the up-down direction. The upper restricting wall 77 is separated upward from the lower restricting wall 76. The protrusion 74 is disposed between the lower restricting wall 76 and the upper restricting wall 77 so as to be vertically movable.

As shown in FIG. 1, an operation portion 78 is disposed around the opening 28 in the top plate 27 so as to be vertically movable. As shown in FIGS. 3 and 4, an upper end of the rod 73 is connected to an operation portion 78.

As shown in FIG. 6, the rod 73 includes a pressing portion 81 and a non-pressing portion 82 below the protrusion 74. The non-pressing portion 82 is located below the pressing portion 81. A rear surface 81a of the pressing portion 81 is located rearward of a rear surface 82a of the non-pressing portion 82 in the axially orthogonal direction. The non-pressing portion 82 has an inclined surface 84 at a lower end thereof. The inclined surface 84 is inclined with respect to the vertical plane such that the lower side of the inclined surface 84 is located forward in the second direction and forward in the axially orthogonal direction.

As shown in FIGS. 1 and 5, when the rod 73 is located at the reference position, the protrusion 74 is in contact with the upper restricting wall 77. The upper surface 78a of the operation portion 78 is located on the same plane as the upper surface 27a of the top plate 27. At this time, as shown in FIGS. 5 and 6, the pressing portion 81 is located above the central shaft 67. The non-pressing portion 82 is located forward of the end 26b of the elongated hole 26 in the axially orthogonal direction (forward in the second direction).

When the rod 73 located at the reference position is operated to be pushed down toward the pushed-down position, the pressing portion 81 presses the central shaft 67 toward the front side in the first direction (toward the end 26a of the elongated hole 26) in accordance with the push-down operation.

As shown in FIG. 11, when the rod 73 is located at the pushed-down position, the protrusion 74 is in contact with the lower restricting wall 76. Although not shown, the upper surface 78a of the operation portion 78 is located at a position lower than the upper surface 27a of the top plate 27. At this time, the non-pressing portion 82 is located below the central shaft 67. A rear portion of the pressing portion 81 overlaps an end 26b of the elongated hole 26 in the axially orthogonal direction.

### Turnover Spring 86

The turnover spring 86 has a function of urging the rod 73 and reversing a direction in which the rod 73 is urged at an intermediate position between the reference position and the pushed-down position. In the present embodiment, a coil spring is used as the turnover spring 86. The turnover spring 86 is bridged between the protruding wall 75 and the protrusion 74 so as to urge the rod 73 in the following manner.

When the rod 73 is located between the reference position (refer to FIG. 5) and the intermediate position, the rod 73 is urged upward toward the reference position.

When the rod 73 is located between the intermediate position and the pushed-down position (refer to FIG. 11), the rod 73 is urged downward toward the pushed-down position.

### Push-up Portion 88

As shown by a broken line in FIG. 5, the push-up portion 88 is formed at a portion of the linkage member 55 which satisfies the following condition.

By rotating around the rotation shaft 22 integrally with the lifting gear 57, the lifting gear 57 comes into contact with the inclined surface 84 of the rod 73 located at the pushed-down position, and pushes the rod 73 upward from the intermediate position.

### Operation of the Present Embodiment

When the rod 73 is located closer to the reference position than the intermediate position, a force that urges the rod 73 upward acts on the rod 73 by the turnover spring 86. Therefore, when the rod 73 is not pushed down, the rod 73 is located at the reference position.

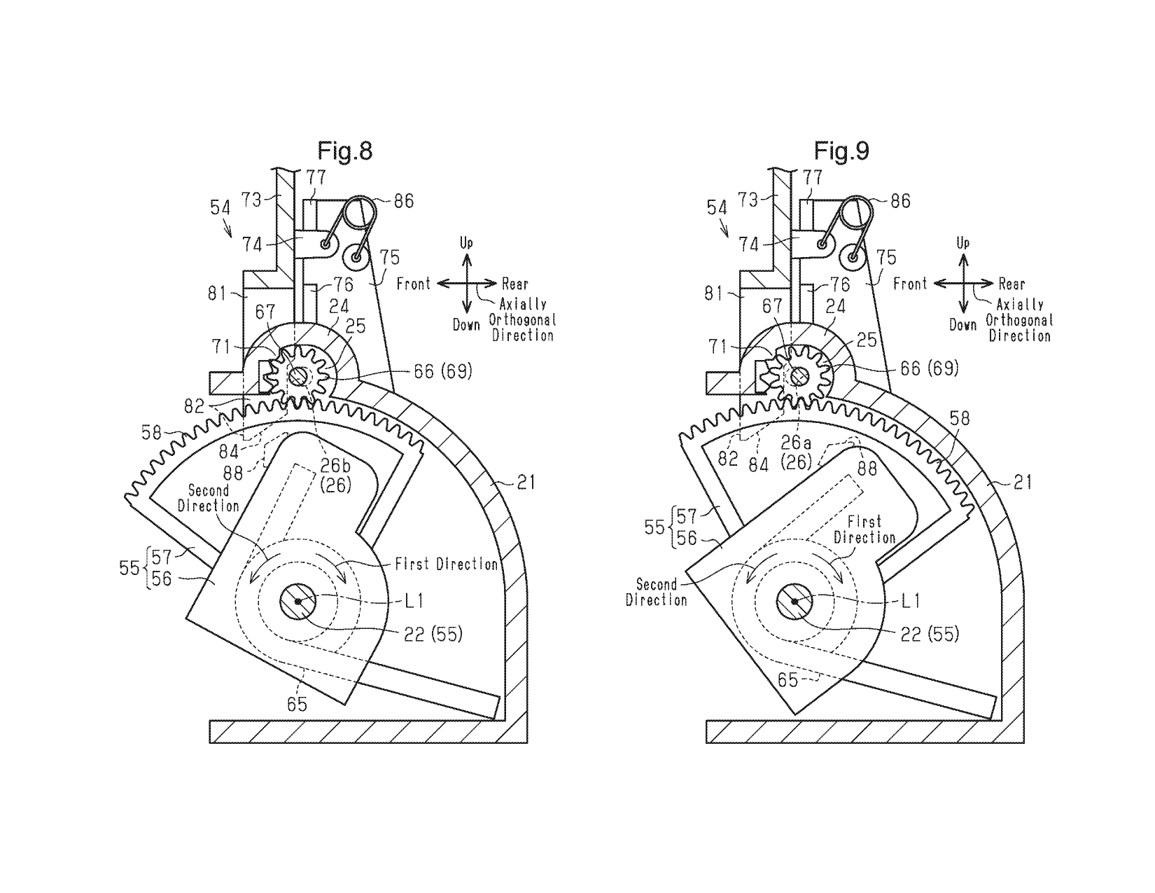

At this time, as shown in FIGS. 7 and 8, the pressing portion 81 is located above the central shaft 67. The non-pressing portion 82 is located in front of the end 26b of the elongated hole 26 in the second direction and in front of the end wall of the elongated hole 26 in the axially orthogonal direction. The rod 73 does not press the central shaft 67 toward the front side (the end 26a of the elongated hole 26) in the first direction. The central shaft 67 of the planetary gear 66, which is subjected to force directed forward in the second direction and forward in the axially orthogonal direction from the lifting gear 57, is located forward in the axially orthogonal direction from the end 26a, for example, at the end 26b or near the end SL. Since the second tooth portion 69 engages with the engagement portion 71, the rotation of the planetary gear 66 is restricted. The lifting gear 57, which is engaged with the second tooth portion 69 at the first tooth portion 58, is restricted from rotating forward in the second direction. Since the tray portion 37 is locked against upward movement by this restriction, the tray portion 37 is held at the height at that time.

As shown in FIG. 7, when an occupant in the vehicle applies a downward force (depressing force) to the tray portion 37 by hand directly or indirectly via a beverage container D2 placed on the tray portion 37 and indicated by a long-dash double-short-dash line, the tray portion 37 is lowered. In addition, the depressing force is transmitted to the linkage member 55 via the link mechanism 43 which contracts along with the lowering, and thus, as illustrated in FIG. 9, the linkage member 55 rotates in the first direction around the rotation shaft 22 against the urging force of the urging member 65 in conjunction with the lowering of the tray portion 37. At this time, a force toward the front in the first direction and toward the rear in the axially orthogonal direction acts on the planetary gear 66 having the second tooth portion 69 meshing with the first tooth portion 58. The central shaft 67 of the planetary gear 66 moves forward in the first direction in the elongated hole 26. This movement is accompanied by the rotation of the planetary gear 66 about the central shaft 67. When the central shaft 67 moves to the end 26a of the elongated hole 26, the second tooth portion 69 is disengaged from the engagement portion 71. The restriction on the rotation of the planetary gear 66 is released. Therefore, when the lifting gear 57 is rotated in the first direction, locking against upward movement of the tray portion 37 is cancelled, and the tray portion 37 is lowered.

When the tray portion 37 is lowered to a desired height and the occupant stops applying the depressing force, the lifting gear 57 is rotated by the urging force of the urging member 65 in a second direction which is a rotating direction opposite to the first direction and in which the tray portion 37 is lifted. At this time, a force directed forward in the second direction and forward in the axially orthogonal direction acts on the planetary gear 66 from the lifting gear 57. The central shaft 67 of the planetary gear 66 moves in the second direction in the elongated hole 26. This movement is accompanied by the rotation of the planetary gear 66 about the central shaft 67. The meshing position of the second tooth portion 69 with the first tooth portion 58 changes. When the planetary gear 66 moves to the second position, the second tooth portion 69 engages with the engagement portion 71, so that the rotation of the planetary gear 66 is restricted. Since the rotation of the lifting gear 57 in the second direction is restricted and the tray portion 37 is locked against upward movement, the tray portion 37 is held at the height at that time.

If the timing at which the depressing force is no longer applied is when the tray portion 37 is lowered to the intermediate position between the uppermost position and the lowermost position, the tray portion 37 is held at the height position shown in FIG. 9, for example. If the timing is when the tray portion 37 is lowered to the lowermost position, the tray portion 37 is held at the lowermost position shown in FIG. 5.

Incidentally, as described above, in a state in which the tray portion 37 is locked against upward movement, when the locking is cancelled, the rod 73 is pushed down from the reference position toward the pushed-down position. FIG. 5 shows a state in which the tray portion 37 at the lowermost position is locked against upward movement. In this state, as shown in FIG. 11, when the rod 73 is pushed down and exceeds the intermediate position, the urging direction of the turnover spring 86 is reversed from upward to downward. Since the rod 73 is urged downward by the turnover spring 86, the push-down operation is assisted.

In accordance with the pressing operation, the pressing portion 81 presses the central shaft 67 of the planetary gear 66 toward the front side in the first direction (toward the end 26a of the elongated hole 26). When the central shaft 67 moves to the end 26a, the second tooth portion 69 is disengaged from the engagement portion 71.

Since the rod 73 is located on the pushed-down position side with respect to the intermediate position, an urging force for urging the rod 73 downward acts on the rod 73 by the turnover spring 86. Therefore, the rod 73 is pushed down to the pushed-down position by the urging force.

At the pushed-down position, as described above, since the second tooth portion 69 is disengaged from the engagement portion 71, the rotation restriction of the planetary gear 66 is released.

In addition, an urging force for rotating the lifting gear 57 in the second direction is applied to the lifting gear 57 by the urging member 65. Therefore, the lifting gear 57 is rotated in the second direction together with the push-up portion 88 by the urging force of the urging member 65.

Although not shown in the drawings, when the push-up portion 88 comes into contact with the inclined surface 84 and a raising force of a magnitude that overcomes the urging force of the turnover spring 86 is applied to the rod 73, the rod 73 is pushed up. When the rod 73 exceeds the intermediate position, the direction in which the turnover spring 86 urges the rod 73 is reversed. As shown in FIG. 5, the rod 73 is pushed up to the reference position by the turnover spring 86.

### Advantages of the Present Embodiment

(1) As shown in FIG. 5, the lock mechanism 54, which releasably locks the tray portion 37 against upward movement, includes the linkage member 55, the urging member 65, the intermediate member (the planetary gear 66), and the engagement portion 71. The linkage member 55 moves in the first direction when the tray portion 37 is lowered, and moves in the second direction when the tray portion 37 is raised. The urging member 65 urges the linkage member 55 in the second direction. The intermediate member includes the second tooth portion 69 in a state of meshing with the first tooth portion 58 of the linkage member 55. The intermediate member moves between the first position and the second position. When the intermediate member is located at the second position, the engagement portion 71 is engaged with the second tooth portion 69, thereby restricting the movement of the linkage member 55 in the second direction and locking the tray portion 37 against upward movement. As shown in FIG. 9, when the intermediate member is located at the first position, the engagement portion 71 is disengaged from the second tooth portion 69 to cancel the restriction on the rotation of the planetary gear 66. Accordingly, the restriction of the rotation of the lifting gear 57 in the second direction is cancelled, so that the lock against upward movement of the tray portion 37 is cancelled.

Therefore, the height position of the tray portion 37 can be adjusted to an appropriate arbitrary height position corresponding to the height of the beverage containers D1 and D2 by adjusting the timing at which the depressing force is not applied to the tray portion 37.

Further, as shown in FIGS. 7 and 10, even in the case of the beverage containers D1 and D2 having different heights, many portions except for the upper ends can be accommodated in the accommodation portion 32. Therefore, the heat insulating effect and the cold insulating effect by the heat insulating portion 35 can be enhanced. That is, it is possible to enhance the effect of suppressing a change in the temperature of each of the beverage containers D1 and D2 themselves and the beverage therein for a long time. In addition, even the beverage containers D1 and D2 having different heights can be accommodated in the accommodation portion 32 in a stable state. The cup holder 20 does not require a holding mechanism for holding the beverage containers D1 and D2 in a stable state. Further, even if the beverage containers D1 and D2 have different heights, the beverage containers D1 and D2 can be easily taken out from the accommodation portion 32 by exposing the upper ends of the beverage containers D1 and D2 from the upper surface 27a of the top plate 27 by certain lengths. It is also possible to suppress obstruction due to an increase in the exposed portion.

(2) As shown in FIGS. 5 and 9, the linkage member 55 includes the lifting gear 57, which rotates in the first direction when the tray portion 37 is lowered and rotates in the second direction when the tray portion 37 is raised. The intermediate member is formed by the planetary gear 66 arranged adjacent to the lifting gear 57. The central shaft 67 of the planetary gear 66 is inserted into the elongated hole 26, which extends in the axially orthogonal direction, so as to be movable in the axially orthogonal direction. The position of the planetary gear 66 when the central shaft 67 is located at the front end 26a in the first direction of the opposite ends of the elongated hole 26 in the axially orthogonal direction is defined as the first position.

Therefore, when the occupant applies a depressing force to the tray portion 37, the second tooth portion 69 is disengaged from the engagement portion 71. By releasing the restriction of the rotation of the planetary gear 66 and rotating the lifting gear 57 in the first direction, the tray portion 37 can be lowered.

Further, when the tray portion 37 is lowered to a desired height, the occupant stops applying the depressing force, whereby the second tooth portion 69 is engaged with the engagement portion 71. By restricting the rotation of the planetary gear 66 by this engagement, the rotation of the lifting gear 57 in the second direction can be restricted. The tray portion 37 can be locked against upward movement by restricting rotation of the lifting gear 57. The tray portion 37 can be held at the height position at that time.

(3) The rod 73 is used as a mechanism for cancelling the lock. The rod 73 includes the pressing portion 81 and moves vertically between the reference position and the pushed-down position. When the rod 73 is located at the reference position, the pressing portion 81 is located above the central shaft 67 as shown in FIG. 5. When the rod 73 located at the reference position is pushed down, the central shaft 67 is pressed in the first direction by the pressing portion 81 as shown in FIG. 11 in accordance with the push-down operation.

Therefore, as shown in FIG. 5, when the rod 73 is located at the reference position, the second tooth portion 69 can be engaged with the engagement portion 71. By restricting the rotation of the planetary gear 66 by this engagement, it is possible to restrict the rotation of the lifting gear 57 in the second direction and lock the tray portion 37 against upward movement.

Further, when the rod 73 is pushed down from the reference position to the pushed-down position, as shown in FIG. 11, the central shaft 67 can be pushed in the first direction by the pressing portion 81. By disengaging the second tooth portion 69 from the engagement portion 71 and releasing the restriction of the rotation of the planetary gear 66, the restriction of the rotation of the lifting gear 57 in the second direction can be released, and thus the locking against upward movement of the tray portion 37 is cancelled.

(4) As shown in FIGS. 5 and 11, the direction in which the rod 73 is urged is reversed by the turnover spring 86 at the intermediate position between the reference position and the pushed-down position.

Therefore, when the push-down operation is not performed on the rod 73, the rod 73 can be located at the reference position. Further, by pushing down the rod 73 to a position beyond the intermediate position, the downward urging force of the turnover spring 86 can assist the rod 73 to be pushed down to the pushed-down position.

(5) As indicated by a broken line in FIG. 8, the linkage member 55 is provided with the push-up portion 88.

Therefore, when the depressing force is no longer applied to the rod 73 located at the pushed-down position, the rod 73 can be pushed up above the intermediate position by the push-up portion 88. When the rod 73 exceeds the intermediate position, the direction in which the turnover spring 86 urges the rod 73 is reversed, so that the rod 73 can be pushed up to the reference position shown in FIG. 5 by the turnover spring 86.

### Modifications

The above-described embodiment may be modified as follows. The above-described embodiment and the following modifications can be combined if the combined modifications remain technically consistent with each other.

The lifting gear 57 may be constituted by a rack gear. Further, the intermediate member may be constituted by a rack gear, and the lifting gear 57 may be constituted by a pinion gear. Even in these modifications, it is possible to obtain the same effects as those of the above-described embodiment.

When the central shaft 67 of the planetary gear 66 is moved forward in the axially orthogonal direction in the elongated hole 26, the planetary gear 66 rotates (idly runs) until the second tooth portion 69 is engaged with the engagement portion 71. In accordance with the rotation, the lifting gear 57 also rotates, and the tray portion 37 is lifted. In order to suppress this phenomenon, a damper such as an oil damper may be coupled to the central shaft 67 of the planetary gear 66. According to this modification, resistance is applied to the rotation of the central shaft 67 by the damper to reduce the rotation speed of the central shaft 67. Then, since the rotation (idle running) of the planetary gear 66 is suppressed, it is possible to suppress the rotation speed of the lifting gear 57 and to suppress unnecessary lifting of the tray portion 37.

Instead of the turnover spring 86, a spring such as a compression spring that urges the rod 73 upward may be used. In this modified example, when the depressing force is no longer applied to the rod 73, the rod 73 is returned to the reference position by the urging force of the spring. Therefore, the push-up portion 88 can be omitted.

A spring of a type different from the torsion coil spring may be used as the linkage member 55 or a member different from the spring may be used as the linkage member 55 as long as the member urges the linkage member 55 in the second direction.

One or both of the heat insulating portion 35 and the damper 63 may be omitted as appropriate.

The cup holder of the present invention may be installed and used in a place different from the passenger compartment of the vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A cup holder configured to hold a beverage container, comprising:
a tray portion configured to be vertically movable and configured such that the beverage container is placed thereon; and
a lock mechanism configured to releasably lock the tray portion against upward movement, wherein
the lock mechanism includes:
a linkage member that is operatively connected to the tray portion, includes a first tooth portion, moves in a first direction when the tray portion is lowered, and moves in a second direction opposite to the first direction when the tray portion is raised;
an urging member that urges the linkage member in the second direction;
an intermediate member that includes a second tooth portion in mesh with the first tooth portion, and moves between a first position and a second position located forward of the first position in the second direction; and
an engagement portion configured such that
when the intermediate member is located at the second position, the second tooth portion is engaged with the engagement portion so that the engagement portion restricts movement of the linkage member in the second direction to lock the tray portion against upward movement, and
when the intermediate member is located at the first position, the second tooth portion is disengaged from the engagement portion so that the engagement portion allows movement of the linkage member in the second direction to unlock the tray portion, thereby allowing the tray portion to move upward.

2. The cup holder according to claim 1, wherein
the linkage member includes a lifting gear that includes the first tooth portion on an outer peripheral portion thereof,
the lifting gear rotates in the first direction about a rotation shaft when the tray portion is lowered, and rotates in the second direction, which is a rotation direction opposite to the first direction, about the rotation shaft when the tray portion is raised,
a direction in which the rotation shaft extends is defined as an axial direction,
a direction orthogonal to both the axial direction and a vertical direction is defined as an axially orthogonal direction,
the intermediate member includes a planetary gear disposed adjacent to the lifting gear,
the planetary gear includes a central shaft extending in the axial direction, and a planetary gear main body including the second tooth portion on an outer peripheral portion thereof and configured to rotate about the central shaft,
the central shaft is inserted into an elongated hole extending in the axially orthogonal direction so as to be movable in the axially orthogonal direction, and
a position of the planetary gear when the central shaft is located at a front end in the first direction of opposite ends of the elongated hole in the axially orthogonal direction is defined as the first position.

3. The cup holder according to claim 2, wherein
the lock mechanism further includes a rod configured to be vertically movable between a reference position and a pushed-down position lower than the reference position,
the rod includes a pressing portion,
when the rod is located at the reference position, the pressing portion is located above the central shaft, and
when the rod is pushed down to the pushed-down position, the pressing portion presses the central shaft in the first direction in accordance with the pushing-down operation.

4. The cup holder according to claim 3, wherein
the lock mechanism further includes a turnover spring that reverses a direction in which the rod is urged at an intermediate position between the reference position and the pushed-down position, and
the turnover spring urges the rod upward when the rod is located between the reference position and the intermediate position, and urges the rod downward when the rod is located between the intermediate position and the pushed-down position.

5. The cup holder according to claim 4, wherein the linkage member is provided with a push-up portion that pushes up the rod located at the pushed-down position to a position above the intermediate position by rotating integrally with the lifting gear around the rotation shaft.
